(19) United States
(12) Patent Application Publication
(10) Pub. No.: US 2025/0085620 A1
(43) Pub. Date: Mar. 13, 2025

(54) PORTABLE HANDHELD PROJECTION SYSTEM WITH CONNECTOR MODULE

(71) Applicant: Joshua H. Rossen, Solon, OH (US)

(72) Inventor: Joshua H. Rossen, Solon, OH (US)

(21) Appl. No.: 18/821,386

(22) Filed: Aug. 30, 2024

Related U.S. Application Data
(60) Provisional application No. 63/581,413, filed on Sep. 8, 2023.

(51) Int. Cl. G03B 21/30

(52) U.S. Cl. CPC G03B 21/30

(57) ABSTRACT

A handheld projection apparatus (and associated process) and system for a mobile computing device comprising: a light source and an optics assembly in a device housing that carries or at least partially contains each of the foregoing as a portable unit. The projection apparatus is configured to physically connect with the mobile computing device using a unique stabilization connector module.

### CROSS-REFERENCE TO RELATED APPLICATIONS

The present application claims the benefit of the filing date of U.S. Application No. 63/581,413, filed Sep. 8, 2023, the contents of which are expressly incorporated by reference in their entirety.

### FIELD

The present teachings relate generally to optical projection devices for a computer. The present teachings more particularly relate to portable handheld optical projectors compatible with a mobile computing device, particularly a tablet or cell phone and a connector for use therewith.

### BACKGROUND

Traditional optical projectors are useful for exhibiting a display of a computing device. An optical projector exhibits a display of a computing device by emitting a beam of light with the display embodied in the beam of light in a plane perpendicular to the direction of travel of the light beam. The display is visible to a user on a viewing surface (typically located one or more meters away from the user) when the light beam contacts the viewing surface.

It is known in the art to use optical projectors with computers to exhibit a display. Typically, optical projectors are devices that rest on a surface, such as a table, or are mounted to a ceiling and project optically visible images onto a viewing surface (e.g., a remote viewing surface such as a passive screen). Optical projectors are usually connected to a computer using a cable. These types of traditional optical projectors tend to be large, heavy, and not suitable for portable use. For example, traditional projectors may weigh pounds or tens of pounds and have a longest dimension which is a foot or more. This weight is inconvenient for a user who requires a portable projector. Additionally, a device which has any dimension which is a foot or greater will not fit in a typical clothing pocket and is inconvenient to travel with. Thus, a portable optical projector is needed.

A micro projector is described in US 2016/0044291 A1 which allows for projecting a display from a phone. The micro projector described may interface with a cell phone through a magnetic connection or using a cable. The magnetic connection utilizes magnets in the cell phone and corresponding magnets in the mini projector to create electrical connections between the devices using pogo pins. The micro projector fails to account for the fact that most cell phones do not have compatible magnets or pogo pin contacts to couple with the micro projector and aftermarket installation of these components would require unreasonable complexity and labor. A portable projector which does not rely on magnets and pogo pins is needed.

A projector housing is described in U.S. Pat. No. 10,425,516 B2. The projector housing is a case for a phone which has an optical projector integrated within the case. A phone must be inserted into the projector housing to project a display. However, the projector housing fails to offer an ideal portable projector because it increases the size and weight of the phone when the phone resides within the housing. More importantly, the housing is designed to fit only one specific phone shape which makes the projector housing particularly unsuitable for general use.

Therefore, the objective of the present disclosure is to offer a portable projection apparatus which is lightweight, compact, easily affixable and removable, and capable of interacting with a plurality of computing devices. It is a further objective of the present disclosure to offer a portable projection apparatus which is capable of functioning through physical connection, wireless connection, or a combination thereof to a computing device. Finally, the objective of the present disclosure is to offer a portable projection apparatus which can be externally powered, internally powered, supply power to a computing device, or a combination thereof.

What is needed is a portable projection apparatus which is light enough and small enough to comfortably carry in a typical clothing pocket. What is needed is a portable projection apparatus which is easily affixed to and removed from any computing device. What is needed is a portable projection apparatus which is capable of being self-powered, externally powered, and/or powering a computing device.

### SUMMARY

The present teachings relate to a portable and preferably handheld projection apparatus (and associated process) for a computing device (particularly a mobile computing device) comprising: a light source and an optics assembly in a device housing that carries or at least partially contains each of the foregoing as a portable unit. The projection apparatus is configured to physically connect with the computing device, optionally without the use of a cable, and to thereby project an image outwardly of the device (such as for remote viewing) based upon data supplied by the computing device.

In more particularity, the present teachings relate to a handheld projection apparatus for a computing device (e.g., a mobile computing device) comprising: a light source; an optics assembly that receives light from the light source and projects it outwardly as a light beam; at least one processor configured to receive a signal from a computing device and issue a signal to the light source to output light from the light source; a power source configured to receive, store, and provide electrical power; a device housing that carries or at least partially contains each of the foregoing as a portable unit; a male connector projecting from the device housing and in electrical communication with the at least one processor; a female connector in the device housing and in electrical communication with the at least one processor; optionally, a heat sink for removing heat from the at least one processor, light source, power module, or a combination thereof; optionally, one or more connectors (e.g., male connectors or female connectors) configured to transfer electrical signals and/or electrical power from an external source to the processor and/or power source; optionally, a printed circuit board, that carries the light source, at least one optical element, at least one processor, or any combination thereof; and wherein the projection apparatus is configured to physically connect with the computing device via the male connector without the use of a cable.

In one particularly preferred approach the projection apparatus is configured to physically connect with the computing device via a stabilization connector module that optionally has articulation capability in three-dimensions (e.g., by only a manually applied force, by a motor applied force or a combination) about at least 1, 2, 3, 4, 5 or 6 axes. It is understood that articulation about at least 6 axes would involve articulation for translating in each of the x, y, and z planes of a cartesian coordinate system, and also articulation about each of the x, y and z axes. An example of a stabilization connector module may include a base portion, an articulation portion, and a carrying portion. These portions may be configured to enable one or more degrees of articulation relative to each other. Any of these portions may include one or more arms. Any of these portions may include a heat exchanger.

The present teachings relate to a process for exhibiting a display using a projection apparatus of the present teachings comprising the steps of: a connection step where a computing device (e.g., a mobile computing device) is affixed to a connector (e.g., a male connector) of the projection apparatus (e.g., via a stabilization connector module) such that the computing device is in electrical communication with a processor of the projection apparatus; a charging step where the power source of the projection apparatus may receive power from the computing device, supply power to the computing device, or both; a processing step where raw display data from the computing device is converted by a processor into data which is capable of instructing a light source; a data output step where the data is sent from the processor to the light source; and a display projection step where the light source emits light through an optics assembly resulting in a light beam which creates a display on a viewing surface. In one preferred embodiment, the process may also include a step of articulating the projection apparatus and the computing device relative to each other in three-dimensional space about at least 1, 2, 3, 4, 5 or 6 axes (e.g., using a stabilization connector module as described herein).

In another example of the present teachings, the stabilization connector module may be an integrated part of the projection apparatus. For instance, the projection apparatus may include one device housing that is common to both the projection apparatus and the stabilization connector module.

### BRIEF DESCRIPTION OF THE DRAWINGS

FIG. 1 is a front view of a portable projection apparatus.

FIG. 2 is a side view of a portable projection apparatus.

FIG. 3 is a back view of a portable projection apparatus.

FIG. 4 is a bottom view of a portable projection apparatus.

FIG. 5 is an exploded perspective view of a portable projection apparatus.

FIG. 6 illustrates a portable projection apparatus projecting a display.

FIG. 7 is a flow diagram illustrating steps used in operation of an illustrative device of the present teachings.

FIG. 8 is a schematic of hardware useful in a system with a device of the present teachings.

FIG. 9 is a schematic view of an illustrative stabilization connector module.

FIG. 10 is a schematic view of an illustrative stabilization connector module connecting a computing device and a portable projection apparatus, according to another embodiment.

### DETAILED DESCRIPTION

The explanations and illustrations presented herein are intended to acquaint others skilled in the art with the present teachings, its principles, and its practical application. The specific embodiments of the present teachings as set forth are not intended as being exhaustive or limiting of the present teachings. The scope of the present teachings should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description. All patents and printed publications recited herein are hereby incorporated by reference in their entireties for all purposes.

The present teachings relate to a projection apparatus and use of the projection apparatus with a stabilization connector module (as described herein). The projection apparatus may be useful in situations where use of a traditional projector is undesirable or impossible. For example, the projection apparatus may be used in remote locations where external AC power is unavailable. Another example may include use in a meeting room where there is no existing projector. The small size and light weight of the projection apparatus of the present teachings are optimal for use of the projection apparatus in almost any scenario. Desirably, the teachings relate to a portable and preferably handheld projection apparatus (and associated process) for a computing device comprising: a light source and an optics assembly in a device housing that carries or at least partially contains each of the foregoing as a portable unit. The projection apparatus preferably is configured to physically connect with the computing device, optionally without the use of a cable, and to thereby project an image outwardly of the device based upon data supplied by the computing device. In one particularly preferred approach the projection apparatus is configured to physically connect with the computing device via a stabilization connector module (as described herein) that optionally has capability in three-dimensional space of articulation about at least 1, 2, 3, 4, 5 or 6 axes.

Such structures may include a plurality of arms that are pivotally connected to each other (e.g., at their end regions). One example of a suitable connector module may include a ball joint that is clampable (e.g., by a screw that engages a ball in a socket) that is affixed to an elongated arm (which arm itself may be telescopically configured) and/or fixed to a support for translation relative to the support. Other examples are provided herein and are applicable to all embodiments.

A stabilization connector module in accordance with the teachings may include a base portion that is configured to receive either the computing device or the projection apparatus. There may be a carrying portion that receives and carries the other of the computing device or the projection apparatus. The structure for providing multi-axis articulation of the computing device or the projection apparatus relative to each other (e.g., articulation portion) may be located intermediate of the base portion and the carrying portion. In this case, either or both of the base portion and the carrying portion may be configured to include an electrical connector for connecting the computing device and projection apparatus in signaling communication with each other (e.g., by a bus bar arrangement, it being understood that signaling communication may be achieved wirelessly also).

The base portion, the carrying portion or both (either or both of which may be an arm or some other body structure) may include a power source or a connector that is attached to a power source. Either or both of the base portion or the carrying portion may be configured such that it forms a stable interface with a tabletop or other horizontal surface. For example, as part of the base portion there may be a body (e.g., an elongated body) of sufficient mass and center of gravity to avoid tipping of the body due to weight of the remainder of the stabilization connector module and either the computing device or projection apparatus carried by the carrying portion. It is possible that either or both of the computing device or the projection apparatus may be carried on the stabilization connector module for providing multi-axis translation (e.g., on an arm of the stabilization connector module).

It is possible that the carrying portion, the base portion or both include a heat sink or other suitable heat exchanger for drawing heat away from either or both of the computing device or the projection apparatus. Any of the heat exchangers suitable for use herein may include a heat sink (e.g., a passive heat sink or an active heat sink). The heat exchanger may also include a source of forced air flow (e.g., a motor driven fan or blower). The heat exchanger may thus include a plural finned metallic (e.g., copper, silver, aluminum or otherwise) body that is in thermal (e.g., conductive) communication with the heat sources of the computing device or the projection apparatus. The heat exchanger may also employ a heat exchange fluid that is circulated for removing heat. Thus, it may be possible that either or both of the base portion or the carrying portion includes a plurality of fins.

The projection apparatus may be configured to effectively operate to display an image based upon data from a computing device. For instance, the projection apparatus may operate to exhibit a display of a computing device by receiving a signal from the computing device which corresponds to a desired display output. The projection apparatus may convert a signal from a computing device into a light beam which is emitted from a light source through an optics assembly. The interaction between a viewing surface and a light beam may result in exhibition of the desired display output on a viewing surface external of the projection apparatus. A user may thus be able to view the outputted display as an additional graphical output from the computing device. The projection apparatus may be contained in its own device housing such that it is structurally independent of the computing device. However, it is possible that a computing device could include such a projection apparatus as a unitary structure within the computing device.

The projection apparatus may include a device housing. The device housing may contain and constrain the other components of the projection apparatus. The device housing may allow for electrical signals, electrical power, wireless signals, visible light, or any combination thereof to enter and exit the housing. The device housing may have any suitable shape. The device housing may have a prismatic or other shape which may include rounded corners or edges. The device housing may more specifically have a square front surface and a thickness which is less than the length of an edge of the square. The device housing may also house, or be configured to securingly attach with, a stabilization connector module as described herein.

The device housing may be made of a metal, plastic, or other suitable material. The device housing may more specifically be formed of a thermoplastic which may include ABS, Nylon, polyethylene, PLA, PETG, ASA, other thermoplastic, or mixtures thereof. A device housing may be formed by a molding process, casting process, 3D printing process, or other similar manufacturing process. The device housing may be formed of a composite material which includes a thermoplastic, a thermoset or a combination thereof combined with chopped fibers, continuous fibers, or a combination thereof. In order that the device housing may also house, or be configured to securingly attach with, a stabilization connector module as described herein, one or more portions of the device housing may include an elastomeric portion (e.g., made from a thermoplastic elastomer, a thermoset elastomer or a mixture thereof). The elastomeric portion may be dimensioned and configured to enable the projection apparatus and computing device to which it is connected to articulate relative to one another (e.g., about at least 1, 2, 3, 4, 5 or 6 axes). The elastomeric portion (or some other flexible portion) may be configured to include a bellows or corrugated structure boot to facilitate elastic bending. Such boot provides protection to joints during transport and handling. It also may help avoid pinching of surfaces that may otherwise come in contact with the joint during use.

The device housing (including any stabilization connector module component comprised therewith) may have a hollow interior. The device housing may comprise two or even more pieces which are assembled into a housing. The device housing may be assembled of two or more pieces which are affixed to each other using integral snap features, fasteners, or a combination thereof. The device housing may have one or more passages through any portion of the device housing. The one or more passages of the device housing may allow for a male connector to pass through. The one or more passages may be unoccupied and allow for air to pass through the device housing for convective cooling of a projection apparatus.

Concepts of the teachings in this description envision that there may be a stabilization connector module to help secure the projection apparatus to the computing device and to allow the projection apparatus to articulate relative to the computing device. The stabilization connector module may include one or more arms to provide support and/or stability to either or both of the projection apparatus and the computing device. The stabilization connector module may include its own heat sink to aid in transferring heat from the projection apparatus and/or the computing device. The heat sink may be attached (directly or indirectly) to one or more arms that provide support and/or stability. The attachment may be so that the heat sink can articulate relative to the one or more arms. The articulation may be about at least 1, 2, 3, 4, 5, or 6 axes. For example, the attachment may be such that there is a telescoping connection between the heat sink and the one or more arms allowing for translation of the heat sink relative to the one or more arms. In regard to any stabilization connector module component that is part of the housing, a collar, sheath, cowl or other like boot enclosure may at least partially (or entirely) surround the housing. Such enclosure may overlie or be juxtaposed with the connector (e.g., male connector of the projection apparatus), any articulation joint (e.g., hinge, pivot or the like) of the assembly, or both.

A device housing may have a rear wall which may have an area that is no greater than 400 cm², preferably no greater than 350 cm², more preferably no greater than 150 cm², and even still more preferably smaller than 75 cm². A device housing may have a peripheral wall which has an average width about its perimeter of not greater than 5 cm, more preferably not greater than 4 cm, and still more preferably not greater than 3 cm. A device housing may have a minimum width of less than 1 cm. The device housing may be smooth, textured, or a combination thereof. A device housing may have an opening that receives an optics assembly, wherein the ratio of the area of the opening relative to the total area of a back surface of a device housing is no less than 10% and no more than 90%. Structures having different dimensions, but similar relative proportions that are derivable from the above are also possible.

As indicated, the projection apparatus may include a connector (and particularly a male connector) to allow for the projection apparatus to electrically communicate with a computing device, such as by enabling electrical signals, electrical power, or both to travel to, from, or both the computing device. A male connector may allow for the projection apparatus to electrically communicate with a computing device. A male connector may enable electrical signals, electrical power, or both to travel to, from, or both the computing device. A male connector may be in electrical communication with a processor, a power source, or both. A male connector may be any standard male connector used on computing devices. Standard male connectors may include USB-A, USB-C, Micro USB, Apple Lightning, or any other connector commonly used on computing devices. A connector (e.g., male connector) may project from any side of a device housing. A projection apparatus may function normally if an extension cable is used between a computing device and a male connector. Upon assembly with the stabilization connector module, the connector (e.g., male connector) preferably is protected by an enclosure as described previously. Any such connector (e.g., male connector) may be secured to the projection apparatus, the computing device or both, in a single fixed position. Alternatively, the connector (e.g., male connector) may be secured to enable articulation of the connector (e.g., male connector) relative to one or both of the computing device and the projection apparatus. For example, the connector (e.g., male connector) may rotate relative to the projection apparatus so that the connector (e.g., male connector) may form an angle up to 90 degrees with the front or back surface of the projection apparatus (e.g., a hinge-like movement). By way of another example, the connector (e.g., male connector) may rotate relative to the projection apparatus around an axis that extends through the connector and through the projection apparatus (e.g., from top to bottom). As mentioned earlier, it is possible that the stabilization connector module is integrally formed with the projector apparatus. They may therefore share a common housing.

The projection apparatus may include a female connector. A female connector may allow for the projection apparatus to electrically communicate with another computing device or an external power supply. A female connector may enable electrical signals, electrical power, or both to travel to, from, or both the projection apparatus. A female connector may be in electrical communication with a processor, a power source, or both. A female connector may be any standard female connector used on computing devices. Standard female connectors may include USB-A, USB-C, Micro USB, Apple Lightning, or any other female connector used on computing devices. A female connector may at least partially reside in any wall of the device housing. The stabilization connector module may be configured to include one or more female connectors.

The projection apparatus may include an optics assembly. An optics assembly may function to convert raw light as emitted from a light source into a light beam which carries an embodiment of a display to a viewing surface. The optics assembly facilitates focusing of the light beam such that the exhibited display is clear and not blurry. An optics assembly may take in light emitted from a light source and output a light beam. An optics assembly may adjustably focus the display based on the distance of a viewing surface from the optics assembly. An optics assembly may alternatively have a fixed focal distance. An optics assembly may have its focal distance be automatically or manually adjustable. An optics assembly may have its focal distance be manually adjustable through manual rotation of a portion of the optics assembly relative to the device housing. An optics assembly may have its focal distance automatically adjustable through the use of one or more electrical actuators or motors which adjust the focal length of the optics assembly. An optics assembly may magnify a light source. An optics assembly may have a fixed or adjustable magnification. An optics assembly may comprise one or more optical elements.

The projection apparatus may include an optical element. An optical element may focus, magnify, or both light which is emitted from a light source. An optical element may redirect the path in which light is traveling via refraction. An optical element may take in light from a light source which may or may not have already passed through one or more other optical elements. An optical element may be an optical lens. An optical element may be a concave lens or a convex lens. An optical element may have a fixed focal distance. An optical element may have a magnification. An optical element may be made from a glass, thermoset, thermoplastic, or resin material. An optical element may be made from polycarbonate. A projection apparatus may use multiple optical elements which are made of the same material or any combination of different materials. An optical element may be produced using conventional lens forming techniques or through a 3D printing process. An optical lens may be formed using a stereolithography 3D printing process.

The projection apparatus may include a light source. A light source may generate an embodiment of a display as communicated from a processor which results in a light beam after passing through an optical assembly. A light source may produce light. A light source may be powered by a power source which is an internal or an external power source. A light source may produce a two-dimensional plane of light of varying colors and brightness which is an embodiment of a display. An embodiment of a display produced by a light source may be an upright or inverted version of the display. A light source may have an adjustable brightness. A light source may cumulatively provide at least 300 lumens of light. A light source may comprise pixels. A light source may be a lamp, LED, laser, or any other suitable projector light source. An LED light source may be a conventional LED panel or an organic LED (OLED) panel.

The projection apparatus may include a processor. A processor may primarily function to communicate with a computing device and convert signals from a computing device into signals which control a light source. A processor may receive, send, or both electrical or wireless communications from, to, or both a computing device. A processor may receive, send, or both electrical or wireless communications from, to, or both another computing device. A processor may send, receive or both electrical communications from, to, or both a light source, manage a power source, or any combination thereof. A processor may be one or more microprocessors. A processor may communicate with a computing device through a male connector. A processor may communicate with another computing device through a female connector. A processor may have a wireless communication capability. A processor may communicate with a computing device via Wi-Fi, Bluetooth, or other wireless communication protocol. A processor may be mounted to a device housing directly or may be mounted to a printed circuit board (PCB).

A processor may include a PCB. A PCB may provide a mounting platform for and electrical communication paths between any electrical or electronic components of a projection apparatus. A PCB may reside within and be mounted to a device housing. A processor may be soldered or otherwise affixed to a PCB. A PCB may also have a light source, a power source, a heat sink, or any combination thereof adhered, soldered, or otherwise affixed to its surface.

The projection apparatus may include a power source. A power source may supply electrical power to a processor, a computing device, a light source, heat sink, or any combination thereof. A power source may receive electrical power from a male connector, a female connector, wirelessly (e.g. via inductive power transfer), or any combination thereof. A power source may include any component which is capable of receiving, storing, and supplying electrical power. A power source may include a battery or capacitor. A power source may include a lithium-ion, lead-acid, NiMH, alkaline, or other battery. A power source may include an electrolytic capacitor, a film capacitor, a supercapacitor, or other capacitor. A power source may comprise one or more batteries, one or more capacitors, or any combination thereof. A power source may further comprise a power module which controls charging and discharging of a power source. A power module may prevent overcharging, excessive discharge, or both of a power source. A power module may evaluate the electrical need or surpluses of a projection apparatus, a computing device, another computing device, or a combination thereof and optimize power management between these systems.

The projection apparatus may include a heat sink. A heat sink may prevent component parts of a projection apparatus from overheating. A heat sink may facilitate the transfer of heat from a light source, processor, power source, or combination thereof. A projection apparatus may have more than one heat sink. Heat produced by a light source, processor, power source, or combination thereof may be waste heat. A heat sink may transfer heat to ambient air. A heat sink may transfer heat to other available media with heat capacity. A heat sink may transfer heat via convection, conduction, radiation, or any combination thereof. A heat sink may actively or passively cool a projection apparatus. A heat sink may have a rectangular, trapezoidal, square, circular, disc, or other shape. A passive heat sink may be any component which creates a greater flow of heat through a device housing that would be transferred without the component. A passive heat sink may have a flat, irregular, finned, or other external surface which facilitates the convection, conduction, and/or radiation of heat from a projection apparatus. A heat sink may be a metal or other material with a high thermal conductivity. A heat sink may be made from silver, copper, aluminum, gold, iron, steel, zinc magnesium, manganese, other metals, or any alloys thereof. A heat sink may also be made of nonmetals which may include diamond, graphene, graphite, or the like.

A heat sink may be an active heat sink. An active heat sink may actively transfer heat from a projection apparatus. An active heat sink may utilize electrical power to pump heat. An active heat pump may be a thermoelectric cooling device. A thermoelectric cooling device may actively remove heat from a light source, processor, power source, or combination thereof. A thermoelectric cooling device is desirable because it can be made much smaller than any available vapor-compression refrigeration loop. An active heat sink may be combined with a passive heat sink to form a heat sink. A heat sink may include a thermoelectric cooling device affixed to a finned passive heat sink. An active heat sink may also include an electrical fan which forces air through or over a projection apparatus. It will be appreciated that the stabilization connector module as described herein may provide a location to house any of the above-described heat sink arrangements or other heat sink teachings of the preceding paragraphs. As discussed, the stabilization connector module may include its own additional heat sink having any of the above arrangements or other teachings of the preceding paragraphs. For example, one or more of the arms of the stabilization connector module and/or a structure coupled to the one or more arms, base portion, carrying portion, and/or an articulation portion may include a finned structure to dissipate heat.

The projection apparatus may emit a light beam. A light beam may create a display. A light beam may be formed of substantially parallel rays of light originating from a light source. A light beam may begin at an outer surface of an optics assembly. A light beam may terminate in a display on a viewing surface. A light beam may carry an embodiment of a display in each plane perpendicular to the direction of travel of the light beam.

The projection apparatus may produce a display. A display may function to convey information from a computing device to a user. A display may be a user interface, a desktop screen, or both. A display may result from the interaction between a light beam and a viewing surface. A display may present icons, videos, web browsers, word processors, or any other program or information traditionally exhibited on a laptop display panel or a desktop monitor. A display may be a direct copy or mirrored copy of what is exhibited on the screen of a computing device. Alternatively, a display may not be a direct copy or mirrored copy of what is exhibited on the screen of a computing device.

The projection apparatus may include a viewing surface. A viewing surface may interact with a light beam to produce a display. A viewing surface may be any surface which does not reflect all light. A viewing surface may preferably be flat. A viewing surface which is irregular or otherwise not flat may also be used to exhibit a display.

The projection apparatus may include a computing device. A computing device may provide a signal to a projection apparatus which communicates what a display will exhibit. A computing device may be any electronic device which requires the display of a user interface, desktop screen, or both to operate. A computing device may be a cell phone, tablet, laptop, desktop, electronic wristwatch, camera, or any similar device. A computing device may have a connection feature which is complementary to and capable of communicating through a male connector. Another computing device may be any computing device other than the computing device which is in communication with a projection apparatus through a female connector, wirelessly, or both.

As indicated, the stabilization connector module may be an integrated part of the projection apparatus, thus sharing the housing of the projection apparatus. It may also be provided as its own discrete component. As addressed earlier, the stabilization connector module preferably includes an articulation portion and a stabilization portion. The stabilization connector module may also include a heat sink, which optionally may form part of the articulation portion, the stabilization portion or both. The articulation portion is configured so that when the computing device and the projection apparatus are connected with each other in signaling communication, either or both of the computing device and the projection apparatus can articulate relative to each other. The articulation may be about at least one, two, three, four, five or six axes.

Thus, it is possible that the stabilization connector module will include a hinge, a swivel, a ball and socket, or other articulating joint structure. The articulation portion may include multiple articulating joint structures. Any such articulating joint structure may include some structure to secure the position of the computing device and the projection apparatus relative to each other. For example, there may be a clamp, a cam lock, a locking pin, latch, ratchet, detent, or other securing device that relies upon friction, material elasticity, magnetism, and/or a mechanical (or electromechanical) interaction to secure parts into a desired position. In this way, it is possible to articulate the computing device and the projection apparatus relative to each other (e.g., from a first position to a second position), and then secure them in the resulting position (e.g., the second position) by way of the securing device. It is also a possibility that the stabilization connector module may include one or more components enabling the stabilization connector module to be adjustable between a first dimension and a second dimension. For instance, the stabilization connector module may include a telescoping portion.

The stabilization connector module also may have a stabilization portion. Preferably the stabilization portion includes one or more stabilization arms pivotally connected (e.g., via an articulation joint, such as any of those described herein) to a base portion. The arms desirably may be adjusted to allow either or both of the computing device or the projection apparatus to directly or indirectly rest thereon. For example one or more of the stabilization arms may have a length and may terminate at an end (e.g., a flattened and/or rounded end, which optionally may be at least partially covered or made with an insulating material such as an elastomer (or other polymer) or a ceramic (e.g., glass) or a conductive material such as aluminum, steel or otherwise) against which the computing device, the projection apparatus or both may rest. The distal end of at least one stabilization arm may be magnetic and may be configured to couple to a magnetic portion of the computing device, the projection apparatus, or both.

The stabilization connector module also may have its own heat sink or may support, carry or otherwise receive a heat sink of the projection apparatus. Thus, it is possible that the base portion of the stabilization portion also serves as at least part of (if not entirely) a heat sink. Further, it is also possible that one or more of the stabilizing arms may be thermally conductive and forms part of the heat sink or as a vehicle for conducting heat away from the computing device, the projection apparatus or both.

By way of general illustration, one possible arrangement for a stabilization connector module may include a heat sink attached via a first articulation joint and a second articulation joint, respectively, with a first arm and a second arm. One or more of the arms may have a portion (e.g., a distal end region) that is configured to contact and support a computing device (e.g., smart phone or tablet). At the distal end region of one or more of the arms may be a magnet sized and configured to magnetically attach to the computing device. One or more of the arms may have a portion (e.g., a distal end) that is configured to contact and support and/or stabilize the projection apparatus. For example, an arm may have a surface that grips one or more sidewalls of the projection apparatus, provides a support surface against which a portion of the projection apparatus housing (e.g., a back wall, a side wall or both) abuts or otherwise engages, or a combination. The stabilization connector module may also be configured to be positioned in thermal communication, preferably thermal conduction communication, with and near (e.g., behind) the heat sink of the projection apparatus. To facilitate the support by one or more of the arms, the projection apparatus housing device housing may optionally include as part of a stabilization arm a dock (e.g., a male/female mating arrangement) in lieu of, or in addition to a magnet. The dock may include a partially enclosed receptacle (as a female dock) that defines a cavity into which one of the arms penetrates. Alternatively, or in addition, the dock may include one or more projections that penetrate into a cavity defined in an arm.

The housing of the projector and/or the stabilization connector module may be configured to provide a handle or other gripping structure to facilitate user transport or handling.

Viewed in another way, the present teachings envision that a stabilization connector module may include a base portion, a carrying portion, and an intermediate articulation portion. The articulation portion may include at least one arm, which may be straight and/or may have a curvature to it. The articulation portion may include a plurality of arms that are either in fixed or articulated positioning relative to each other. At one location of the arm (e.g., an end region of the arm) there may be at least one articulation joint. Though such articulation joint may include other features as described herein (e.g., a telescopic portion), it preferably includes a pivot joint. The pivot joint may be a clevis type pivot joint, and/or a ball joint by which a ball in a socket can be manipulated and locked in place (e.g., by a screw or other member bearing against the ball).

The pivot joint may connect to the carrying portion to which the projection apparatus or computing device is secured as described elsewhere herein. In one preferred approach the projection apparatus or computing device is secured to the carrying portion by one or more connectors, and/or support shelves (not shown) (e.g., shelves that may be configured with fins for transferring heat away from the projection apparatus) projecting from the carrying portion. The carrying portion may include an active or passive heat exchanger as previously described.

The other of the computing device or projection apparatus may be connected with and be supported on the base portion. The base portion or the carrying portion may be connected with or may provide its own suitable power supply. For example, either or both of the base portion or the carrying portion may have a rechargeable battery (e.g., a lithium ion type battery).

It is also possible for instance that a wired electrical communication may be included from the base portion (to interface with the computing device or the projection apparatus) to the carrying portion (to interface with the computing device or the projection apparatus). In this manner the computing device and the projection apparatus may be in signaling electrical communication with each other. Any such wired electrical communication may be at least partially enclosed within any or all of the base portion, the carrying portion and the articulation portion.

The arm may also have a pivotal connection as described at another end region. It is also possible that either or both of the base portion or the carrying portion will have a suitable structure to allow for translation of the intermediate articulation portion (e.g., the arm) in an x and/or y direction. For example, a track may be provided that includes a T-slot (e.g., an extruded aluminum profile) and the arm may have a T-shaped nut to slide along the slot. The T-shaped nut may be connected (e.g., using a suitable ball joint adapter) with a ball joint as described for allowing both sliding in the x and y direction and rotational motion. It should also be realized that a clevis type pivot joint or other suitable pivot joint may be employed in lieu of a ball joint. Also, it should be understood that even though a nut is described for locking, a cam lock can be suitably used instead or in addition. Further, for securing the T-shaped nut in place, a suitable cam lock may be employed or other suitable clamp. It is also possible that the T-shaped nut will have a pin that can be spring biased into a hole at locations along the track.

The entirety of, or only portions, of the above assembly including the base portion, the carrying portion, and the intermediate articulation portion may be contained within a suitable housing. The housing may include molded polymeric components that are configured to provide openings for electrical connectors, support surfaces (e.g., shelves, grooved walls, or otherwise), slots for cooling, or otherwise. The housing may also provide a suitable structure at regions near joints to enable the connection or assembly of elastomeric boots covering the joints. For example, a joint boot may have a bellowed configuration for enabling pivoting of a joints.

It should be appreciated that the description of any features in the context of one embodiment applies to that feature relative to other embodiments as well. Thus, some of the particular features are not intended as limiting.

The present teachings may relate to a process of projecting a display. The process may use one or more of the projection apparatuses as disclosed herein. The process may allow for the projection apparatus to exhibit a display of a computing device, receive electrical power, or both.

The process may include a connection step. The connection step may be to prepare a projection apparatus to receive an electrical charge, produce a display, or both. The connection step may include physical insertion of a male connector into a compatible computing device port, establishing wireless communication, insertion of a male connector into a female connector, or any combination thereof. The connection step may include a step of connecting the projection apparatus with the computing device via the stabilization connector module of the present teachings.

A user may undertake the connection step when they wish to exhibit a display using the projection apparatus. The connection step may be completed when data from a computing device is transmitted to a projection apparatus. The process may also include a step of articulating the projection apparatus and the computing device relative to each other for relative translation and rotation in three-dimensional space. The articulation may be about at least 1, 2, 3, 4, 5 or 6 axes (e.g., using a stabilization connector module as described herein).

The process may include a charging step. The charging step may follow the connection step. The charging step may function to charge a power source. The charging step may use electrical power supplied through a male connector, a female connector, or both to charge a power source. The charging step may continue until a power source reaches a maximum capacity. A power source which remains connected to external power may resume charging if the power source falls below full capacity. The charging step may allow for a user input or automatic setting which prevents charging of a computing device by the power source.

The process may include a processing step. The processing step may convert raw data supplied from a computing device into data which is compatible with a light source to produce a display. The processing step may commence in parallel with the charging step.

The process may include a data output step. The data output step transmits processed data from a processor to a light source. Data may be transmitted through a printed circuit board.

The process may include a display projection step. The display projection step may include the light source producing light based on a data input and projection of that light onto a viewing surface. The light source may continuously update the pattern of light produced if new data are continuously supplied from a processor.

### Illustrative Examples

The following descriptions of the Figures are provided to illustrate the teachings herein but are not intended to limit the scope thereof. These examples envision use of a projection apparatus in combination with a computing device. Though not mandatory, the projection apparatus of the examples, may be as described previously. That is, the projection apparatus may be a portable projection apparatus (particularly a portable projection apparatus for a mobile computing device (e.g., a cell phone, a tablet, or otherwise)). In general, it is expected that the projection apparatus will include a light source; an optics assembly that receives light from the light source and projects it outwardly as a light beam; at least one processor configured to receive a signal from a computing device and issue a signal to the light source to output light from the light source; a power source configured to receive, store, and/or provide electrical power; and a device housing that carries or at least partially contains each of the foregoing as a portable unit. There may be a male connector projecting from the device housing and in electrical communication with the at least one processor. There may also be a female connector in the device housing and in electrical communication with the at least one processor. Optionally, a heat sink for removing heat from the at least one processor, light source, power module, or a combination thereof, is provided. Optionally, one or more male connectors or female connectors may be configured to transfer electrical signals and/or electrical power from an external source to the processor and/or power source. Optionally, a printed circuit board may carry the light source, at least one optical element, at least one processor, or any combination thereof. The projection apparatus may be configured to physically connect with the computing device, optionally without the use of a cable, and to thereby project an image outwardly of the device based upon data supplied by the computing device.

Aspects of the general teachings herein, applicable to all embodiments include that the light source may comprise one or more light emitting diodes (LEDs). The light source may be a matrix of pixels which are formed of lite LEDs or organic LEDs (OLEDs).

The optics assembly may include at least two optical elements which are at least two spaced apart optical lenses and the at least two optical elements are contained at least partially within the housing; and wherein the at least two spaced optical lenses may each have the spaces between them adjusted. The optics assembly may include at least one optical element that translates telescopically to a position external of the device housing. The optics assembly may include at least one optical element including one or more 3D printed lenses.

The projection apparatus is contemplated as being compact and portable. Thus, the maximum thickness of any optical element, parallel to an optical axis of the optical element, may be less than 1.0 mm and more preferably less than 0.5 mm; wherein the distance between the at least two optical elements is no greater than 7.0 mm and more preferably less than 5.0 mm. The device housing has a maximum dimension of 6.0 cm and more preferably 3.0 cm.

It is possible that the at least one processor may be contained within the device housing (which may be formed of only one or more than one piece (e.g., by molding)), wherein the processor receives signals wirelessly (e.g. Bluetooth, Wi-Fi), via physical connection, or both.

The projection apparatus may be such that the power source is configured to receive electrical power from an external power source, a computing device, or both; and wherein the power source is configured to transmit stored electrical power to other components of the projection apparatus, the computing device, or both.

In addition to the above, the teachings applicable to, and illustrated by the following examples, envision a process for exhibiting a display using a projection apparatus of the present teachings. The process may comprise the steps of: a connection step (a) where a computing device is affixed to a male connector of the projection apparatus such that the computing device is in electrical communication with a processor of the projection apparatus; a charging step (b) where the power source of the projection apparatus may receive power from the computing device, supply power to the computing device, or both; a processing step (c) where raw display data from the computing device are converted by a processor into data which are capable of instructing a light source; a data output step (d) where the data is sent from the processor to the light source; and a display projection step (e) where the light source emits light through an optics assembly resulting in a light beam which creates a display on a viewing surface. In a particularly preferred embodiment, the process includes connecting the computing device and the projection apparatus with a stabilization connector module (as described herein) therebetween. The connection step may also include affixing another computing device to a female connector of the projection apparatus for projection of a display from the other computing device. The charging step may include the power source drawing power from an external power source through a female connector. The processing step may include inversion of the raw data so that the display exhibited is upright as seen by a user. The data output step includes transmission of the data to the light source via a printed circuit board. The optics assembly may be adjusted (e.g., using the stabilization connector module) such that the display is clearly exhibited on the viewing surface over a range of distances between the optics assembly and the viewing surface.

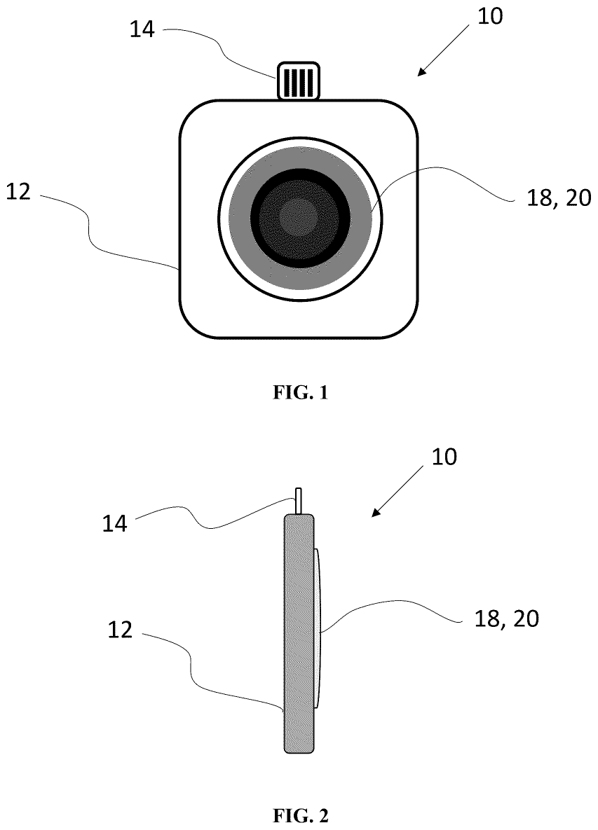

With reference now to the drawings, FIG. 1 is a front view of a projection apparatus 10. The projection apparatus 10 has a device housing 12. The device housing 12 has an optics assembly 18 passing through its surface. The optics assembly 18 includes an optical element 20. A male connector 14 projects from the top of the projection apparatus 10.

FIG. 2 is a side view of a projection apparatus 10. The projection apparatus 10 has a device housing 12. The device housing 12 has an optics assembly 18 passing through its surface. The optics assembly 18 includes an optical element 20. A male connector 14 projects from the top of the projection apparatus 10.

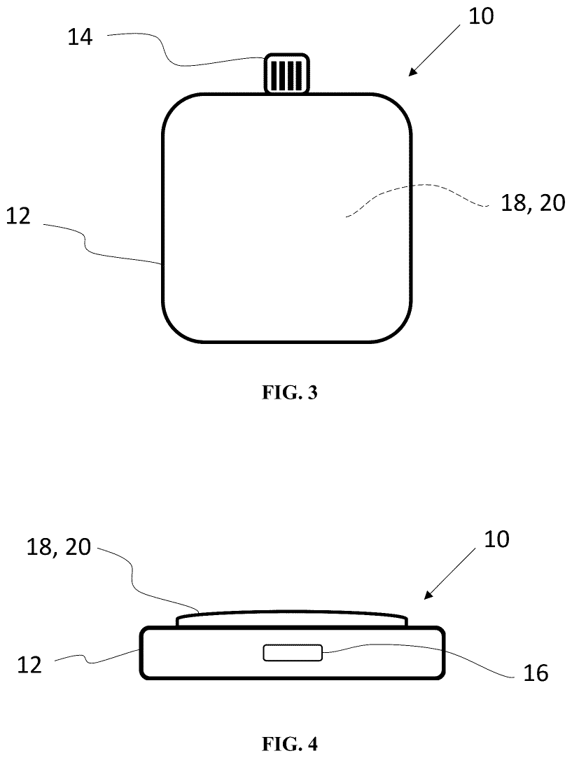

FIG. 3 is a back view of a projection apparatus 10. The projection apparatus 10 has a device housing 12. A male connector 14 projects from the top of the projection apparatus 10.

FIG. 4 is a bottom view of a projection apparatus 10. A female connector 16 is visible as a hole in the bottom of the projection apparatus 10.

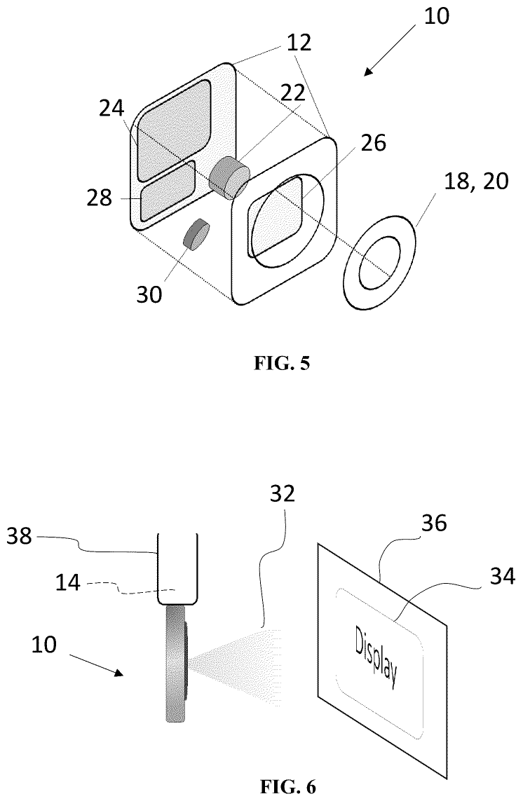

FIG. 5 is an exploded perspective view of a projection apparatus 10. Two pieces are shown which form a device housing 12. The device housing 12 has an optics assembly 18 mounted in a hole through its front surface. The optics assembly 18 includes an optical element 20. Behind the optics assembly 18 is a data acceptor 26 within the device housing 12. A light source 22 is contained in the device housing 12 behind the optics assembly 18. A power source 28 sits next to the light source 22 in the device housing 18. A processor 24 contained in the device housing 12 is in electrical communication with the power source 28 and the light source 22. A heat sink 30 is also contained in the device housing 12 near the processor 24 and the light source 22.

FIG. 6 illustrates a projection apparatus 10 exhibiting a display 34. The projection apparatus 10 is shown connected to a computing device 38. The projection apparatus 10 is shown emitting a light beam 32. The light beam 32 produces a display 34 when it interacts with a viewing surface 36.

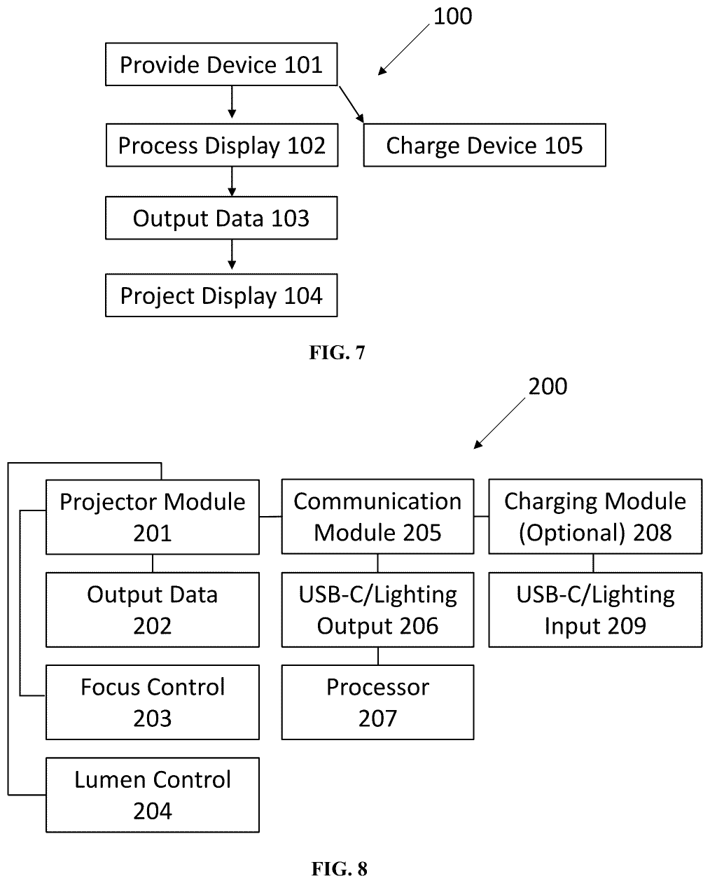

FIG. 7 is a flow diagram illustrating steps used for a process of projecting a display 100. The process begins with a connection step 101. The connection step 101 triggers a processing step 102 and a charging step 105 simultaneously. The processing step 102 is followed by a data output step 103. The data output step 103 is followed by a display projection step 104.

FIG. 8 is a schematic of hardware 200 useful with a projection apparatus 10 of the present teachings. The schematic view exhibits the connections between a projector module 201, output data 202, focus control 203, lumen control 204, communication module 205, connector output 206, processor 207, charging module 208, and connector input 209.

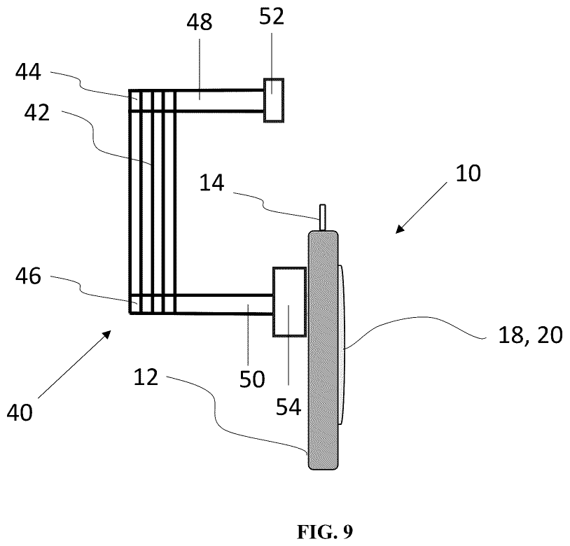

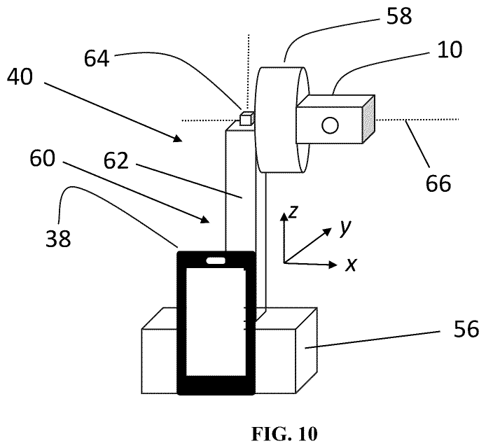

FIG. 9 is a schematic to illustrate the projection apparatus 10 as depicted in FIG. 2, and also including a stabilization connector module 40 as described previously. In the depicted embodiment, the stabilization connector module 40 includes its own heat sink 42. Attached at ends of the heat sink 42 via a first articulation joint 44 and a second articulation joint 46, respectively, are first arm 48 and second arm 50. The first articulation joint 44 and the second articulation joint 46 may be part of an articulation portion. The first arm 48 has a distal end that is configured to contact and support a computing device (e.g., smart phone or tablet) that is not shown in the drawing. At the distal end of the first arm 48 there is a magnet 52, sized and configured to magnetically attach to the computing device 38, thus allowing the first arm 48 to function as and thereby provide a stabilization arm. The first arm 48 may be a base portion (as described relative to FIG. 10) and/or any structure attached to the first arm 48 may be a base portion (e.g., magnet 52). The second arm 50 has a distal end that is configured to contact and support the projection apparatus 10, shown as supporting against a back wall of the housing 12. To facilitate the support by the second arm 50, the device housing 12 of the projection apparatus 10 may optionally include a dock 54 (e.g., a male/female plug connector) in lieu of, or in addition to a magnet such as the magnet employed for the first arm 48. The second arm 50 may be a carrying portion (as described relative to FIG. 10) and/or any structure attached to the second arm 50 may be a carrying portion (e.g., dock, magnet). In the embodiment depicted, the stabilization connector module 40 is configured to be positioned in thermal communication with and near (e.g., behind) the heat sink 30 of the projection apparatus 10 (shown in FIG. 5), and thereby being opposite the optical element 20 relative to the device housing 12.

FIG. 10 illustrates in more detail another embodiment of the present teachings in which a connection module 40 includes a base portion 56, a carrying portion 58 and an intermediate articulation portion 60. The articulation portion 60 includes an arm 62, which (though shown as straight) may have a curvature to it. The arm 62 may have a telescopic portion allowing for movement in the z direction. At one end region of the arm 62 there is shown an articulation joint 64. In this embodiment, though such joint may include other features as described herein (e.g., a telescopic portion), it preferably includes a ball joint by which a ball in a socket can be manipulated and locked in place (e.g., by a screw bearing against the ball). As shown in this embodiment the articulation joint 64 connects to the carrying portion 58 to which the projection apparatus 10 is secured (e.g., by one or more connectors which may be magnetic, and/or support shelves (not shown) (e.g., shelves that may be configured with fins for transferring heat away from the projection apparatus) projecting from the carrying portion 58). The articulation joint 64 and/or the one or more connectors of the carrying portion 58 may be pivotable about at least an axis 66. The carrying portion 58 may include an active or passive heat exchanger as previously described. A computing device 38 may connected with and be supported on the base portion 56. It is possible for instance that a wired electrical communication may be included. It may be at least partially enclosed within any or all of the base portion 56, the carrying portion 58, and the articulation portion 60. The arm 62 may have a pivotal connection at its lower end region akin to that shown by the articulation joint 64. It is also possible that either or both of the base portion or the carrying portion 58 will have a track that allows translation of the arm 62 in an x or y direction. For example, a track may include a T-slot (e.g., an extruded aluminum profile) and the arm may have a T-shaped nut to slide along the slot. The T-shaped nut may be connected (e.g., using a suitable ball joint adapter) with a ball joint as described for allowing both sliding in the x and y direction and rotational motion. Thus, movement in the x, y, and z directions as well as rotation about the x, y, and z axes may be achieved. It should also be realized that a clevis type pivot joint or other suitable pivot joint may be employed in lieu of a ball joint. Also, it should be understood that even though a nut is described for locking a cam lock can be suitably used instead or in addition. Further, for securing the T-shaped nut in place a suitable cam lock may be employed or any other suitable clamp. It is also possible that the T-shape nut will have a pin that can be spring biased into a hole at locations along the track.

The embodiment of FIG. 9 may include any of the features of the embodiment of FIG. 10 and vice versa. For example, the embodiment of FIG. 10 may include a stabilization arm that supports the computing device 38 (with or without a male/female type dock as part of the stabilization arm) or the projection apparatus 10. By way of example the base portion 56 may include a magnetic portion that magnetically attaches to the computing device 38. Further the arrangement of FIG. 9 may include any of the articulation and/or translation features discussed relative to FIG. 10.

Any numerical values recited in the above application include all values from the lower value to the upper value in increments of one unit provided that there is a separation of at least 2 units between any lower value and any higher value. These are only examples of what is specifically intended and all possible combinations of numerical values between the lowest value, and the highest value enumerated are to be considered to be expressly stated in this application in a similar manner. Unless otherwise stated, all ranges include both endpoints and all numbers between the endpoints.

The term “consisting essentially of” to describe a combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist of or consist essentially of the elements, ingredients, components, or steps.

Plural elements, ingredients, components, or steps can be provided by a single integrated element, ingredient, component, or step. Alternatively, a single integrated element, ingredient, component, or step might be divided into separate plural elements, ingredients, components, or steps. The disclosure of “a” or “one” to describe an element, ingredient, component, or step is not intended to foreclose additional elements, ingredients, components, or steps.

What is claimed is:

1. A portable projection system for a mobile computing device comprising:
a) a portable projection apparatus including a light source; an optics assembly that receives light from the light source and projects it outwardly as a light beam; at least one processor configured to receive a signal from a computing device and issue a signal to the light source to output light from the light source; a power source; a device housing (optionally having a maximum dimension of 6.0 cm) that carries or at least partially contains each of the foregoing as a portable unit; at least one heat exchanger for removing heat from the at least one processor, light source, power source, or a combination thereof; and
b) a stabilization connector module including a base portion configured to receive the projection apparatus or a mobile computing device, a carrying portion configured to receive the other of the projection apparatus or the mobile computing device, and an articulation portion between the base portion and the carrying portion, the articulation portion being configured to enable at least one pivotal axis adjustment of the base portion relative to the carrying portion; and at least one of the base portion or the carrying portion includes a heat exchanger for drawing heat away from either or both of the projection apparatus or mobile computing device during operation of the portable projection system wherein upon adjustment of the base portion relative to the carrying portion the resulting positions can be secured in place.

2. The system of claim 1, wherein the articulation portion is connected to either or both of the base portion and the carrying portion by at least one pivotal joint.

3. The system of claim 2, wherein the pivotal joint is selected from a clevis joint, a ball and socket joint or a combination thereof.

4. The system of claim 2, wherein following adjustment of the base portion relative to the carrying portion the resulting positions is secured in place by a compressive force applied to or within the joint.

5. The system of claim 3, wherein the stabilization connector module includes a ball and socket joint, and following adjustment of the base portion relative to the carrying portion the resulting positions is secured in place by a compressive force applied to the ball of a ball and socket joint.

6. The system of claim 2, wherein the system includes a bellows structured boot that at least partially covers the at least one pivotal joint.

7. The system of claim 2 wherein the stabilization connector module includes an adjustable stabilization arm that is telescopic in structure, pivotally movable relative to a portion of the stabilization connector module or both.

8. The system of claim 7, wherein the adjustable stabilization arm has either or both of (i) a magnetic portion that is configured for magnetically connecting the stabilization arm with the mobile computing device to facilitate stabilization of the mobile computing device during use of the system; or (ii) an engagement portion that comprises either a male tip portion for engaging a female dock, or a female tip portion for engaging a male dock.

9. The system of claim 2, wherein the base portion, the carrying portion or both include a heat exchanger for removing heat from at least the projection apparatus.

10. The system of claim 8, wherein the base portion, the carrying portion or both include a heat exchanger for removing heat from at least the projection apparatus.

11. A portable projection system for a mobile computing device comprising:
a) a portable projection apparatus including a light source; an optics assembly that receives light from the light source and projects it outwardly as a light beam; at least one processor configured to receive a signal from a computing device and issue a signal to the light source to output light from the light source; a power source; a device housing having a maximum dimension of 6.0 cm that carries or at least partially contains each of the foregoing as a portable unit; at least one heat exchanger for removing heat from the at least one processor, light source, power source, or a combination thereof; and
b) a stabilization connector module including a base portion configured to receive the projection apparatus or a mobile computing device, a carrying portion configured to receive the other of the projection apparatus or the mobile computing device, and an articulation portion between the base portion and the carrying portion, the articulation portion being configured to enable at least one pivotal axis adjustment of the base portion relative to the carrying portion; and at least one of the base portion or the carrying portion includes a heat exchanger for drawing heat away from either or both of the projection apparatus or mobile computing device during operation of the portable projection system wherein upon adjustment of the base portion relative to the carrying portion the resulting positions can be secured in place by a compressive force; and
wherein the articulation portion is connected to either or both of the base portion and the carrying portion by at least one pivotal joint selected from a clevis joint, a ball and socket joint or both.

12. The system of claim 11, wherein the stabilization connector module includes a ball and socket joint, and following adjustment of the base portion relative to the carrying portion the resulting positions is secured in place by a compressive force applied to the ball of a ball and socket joint.

13. The system of claim 12, wherein the system includes a bellows structured boot that at least partially covers the at least one pivotal joint.

14. The system of claim 12 wherein the stabilization connector module includes an adjustable stabilization arm that is telescopic in structure, pivotally movable relative to a portion of the stabilization connector module or both.

15. The system of claim 14, wherein the adjustable stabilization arm has either or both of (i) a magnetic portion that is configured for magnetically connecting the stabilization arm with the mobile computing device to facilitate stabilization of the mobile computing device during use of the system; or (ii) an engagement portion that comprises either a male tip portion for engaging a female dock, or a female tip portion for engaging a male dock.

16. The system of claim 15, wherein the base portion, the carrying portion or both include a heat exchanger for removing heat from at least the projection apparatus.

17. A portable projection system for a mobile computing device comprising:
a) a portable projection apparatus including a light source; an optics assembly that receives light from the light source and projects it outwardly as a light beam; at least one processor configured to receive a signal from a computing device and issue a signal to the light source to output light from the light source; a power source; a device housing having a maximum dimension of 6.0 cm that carries or at least partially contains each of the foregoing as a portable unit; at least one heat exchanger for removing heat from the at least one processor, light source, power source, or a combination thereof; and
b) a stabilization connector module including a base portion configured to receive the projection apparatus or a mobile computing device, a carrying portion configured to receive the other of the projection apparatus or the mobile computing device, and an articulation portion between the base portion and the carrying portion, the articulation portion being configured to enable at least one pivotal axis adjustment of the base portion relative to the carrying portion; and at least one of the base portion or the carrying portion includes a heat exchanger for drawing heat away from either or both of the projection apparatus or mobile computing device during operation of the portable projection system wherein upon adjustment of the base portion relative to the carrying portion the resulting positions can be secured in place by a compressive force;
wherein the articulation portion is connected to either or both of the base portion and the carrying portion by at least one pivotal joint selected from a clevis joint, a ball and socket joint or both; and
wherein the stabilization connector module includes an adjustable stabilization arm that is telescopic in structure and pivotally movable relative to a portion of the stabilization connector module.

18. The system of claim 17, wherein the stabilization connector module includes a ball and socket joint, and following adjustment of the base portion relative to the carrying portion the resulting positions is secured in place by a compressive force applied to the ball of a ball and socket joint, and wherein the system includes a bellows structured boot that at least partially covers the at least one ball and socket joint.

19. The system of claim 18, wherein the adjustable stabilization arm has either or both of (i) a magnetic portion that is configured for magnetically connecting the stabilization arm with the mobile computing device to facilitate stabilization of the mobile computing device during use of the system; or (ii) an engagement portion that comprises either a male tip portion for engaging a female dock, or a female tip portion for engaging a male dock.

20. The system of claim 19, wherein the base portion, the carrying portion or both include a heat exchanger for removing heat from at least the projection apparatus.
